(19) United States
(12) Patent Application Publication
(10) Pub. No.: US 2010/0162959 A1
(43) Pub. Date: Jul. 1, 2010

(54) HOSE ELEMENT

(75) Inventor: Nils Alveby, Stockholm (SE)

Correspondence Address: YOUNG & THOMPSON, 209 Madison Street, Suite 500, Alexandria, VA, 22314, US

(73) Assignee: DELAVAL HOLDING AB, Tumba (SE)

(21) Appl. No.: 12/601,318

(22) PCT Filed: May 19, 2008
(86) PCT No.: PCT/SE08/50585

§ 371 Date: Nov. 23, 2009

(30) Foreign Application Priority Data
May 22, 2007 (SE) 0701224-8

(51) Int. Cl. A01J 3/00; A01J 5/16

(52) U.S. Cl. 119/14.21; 119/14.51

(57) ABSTRACT

A hose element is configured for a milking device. The hose element includes a first end (3) and a hose portion (1) of a first material. The hose portion extends from the first end along a longitudinal centre axis (x) and has an outer size in a radial plane with respect to the longitudinal centre axis. An attachment section (4) extends around the hose portion in a peripheral direction in the proximity of the first end. The hose element includes a mounting member (10) of a second material which is joined to the hose portion (1). The mounting member includes a primary portion (11), which is joined to the hose portion (1) in the proximity of the attachment section and configured to permit, when being pressed inwardly towards the longitudinal centre axis, a reduction of the outer size of the hose portion at an end portion (5).

The present invention refers to a hose element according to the preamble of claim 1.

Such a hose element may be a part of a teatcup liner or a short milk conduit of a milking member. In a usual application, the first end portion of the hose element is configured to be attached to a claw of the milking member. Typically, the first end portion of the hose element is intended to be introduced into an aperture of the claw in such a way that the groove receives and engages the edge defining the aperture. The first end portion is thus compressed to permit introduction into the aperture. After releasing of the compressing pressure, the first end portion resumes its normal shape, whereby the edge is permitted to enter the groove so that the first end portion is securely mounted in the aperture of the claw. The hose element is elastic but still rather stiff, which means that the pressure to be applied to the first end portion is significant. Furthermore, the pressure is to be distributed in such a way that the outer diameter is reduced over the whole periphery, and not only at two opposite points, in order to permit the introduction into the aperture. Consequently, the mounting of the hose element in the aperture of the claw is a complicated and time-consuming manual work to be performed by the dairy farmer. In order to facilitate this manual work, some kind of separate tool may of course be used. However, such a loose tool has to be carried around by the farmer in order to be at hand when needed. Furthermore, such a separate tool can easily disappear.

### SUMMARY OF THE INVENTION

The object of the present invention is to remedy the disadvantages mentioned above. More specifically, the object of the present invention is to provide a hose element which can be easily and quickly mounted to another element, especially in an aperture of a claw of a milking member.

This object is achieved by the hose element initially defined, which is characterised in that the hose element comprises a mounting member of a second material which is joined to the hose portion, wherein the mounting member comprises a primary portion joined to the hose portion in the proximity of the attachment section and configured to permit, when being pressed inwardly towards the longitudinal centre axis, a reduction of the outer size of the hose portion at an end portion.

Such a mounting member thus forms an integrated part of the hose element. The mounting member will function as a tool by means of which the outer size of the hose portion at the end portion in a convenient and easy manner may be reduced by a user. Thanks to such a size reduction, the hose element may easily be introduced, while the primary portion is still pressed inwardly by the user into any receiving aperture of a further element to which the hose element is to be mounted. It is to be noted that the size reduction may concern the whole periphery of the hose element or a part of the periphery resulting in an oval or somewhat oblong transversal shape of the hose portion. The purpose of the size reduction is not a specific shape but a shape which facilitates the mounting of the hose element in the further element. After release of the pressure, the hose element will go back to the original outer size if not introduced into a aperture of a smaller size. After mounting of the hose element, the mounting member will thus remain on the hose portion, and may thus also be used for facilitating the dismounting of the hose element from the further element.

According to an embodiment of the invention, the end portion encloses the attachment section and the first end. Consequently, the outer size of the first end and the attachment section is reduced by pressing the primary portion inwardly, thus facilitating the introduction into an aperture.

According to a further embodiment of the invention, the secondary material is elastic but more rigid than the first material. This feature ensures that the desired deformation of the first material of the hose portion will take place.

According to a further embodiment of the invention, the mounting member comprises a secondary portion joined to the hose portion and disposed opposite to the primary portion. Thus the end portion of the hose portion is compressed to the reduced outer size during a compressing operation by the primary portion and the secondary portion being pressed towards each other. Advantageously, the secondary portion has a longer extension in a peripheral direction with respect to the longitudinal centre axis than the primary portion. This feature ensures maintaining of an approximately circular shape of the hose portion along the peripheral length of the secondary portion while the radius of this approximately circular shape will be reduced.

According to a further embodiment of the invention, the mounting member comprises a secondary engagement part extending axially from the secondary portion. Such a secondary engagement part may be configured to provide a grip for the user when performing the above-mentioned compressing operation. Advantageously, the secondary engagement part may have an elongated shape.

According to a further embodiment of the invention, the secondary portion is embedded in the first material of the hose portion. Furthermore, the primary portion may be embedded in the first material of the hose portion. In such a way, the outer shape of the hose element may be smooth without any projecting parts. Such a design facilitates cleaning of the hose and improves the hygienic properties.

According to a further embodiment of the invention, also the mounting member comprises a primary engagement part extending axially from the primary portion. Advantageously, the primary engagement part and the secondary engagement part are disposed diametrically opposite to each other. In such a way, the user may easily grip the hose element and perform the above-mentioned compressing operation by pressing the two engagement parts towards each other. Furthermore, the primary engagement part and the secondary engagement part may be connected to a common connection part extending around the hose portion in a peripheral direction. Advantageously, the connection part may be an integrated part of the mounting member and made in the second material. Also the primary engagement part may have an elongated shape.

According to a further embodiment of the invention, the attachment section comprises a groove. Advantageously, the groove is configured to permit the mounting of the hose element to a further element, comprising an aperture defined by an aperture edge, by engaging the aperture edge. In such a case the groove shape of the attachment section is advantageous.

According to an advantageous application of the invention, the hose element comprises or is constituted of a short milk conduit.

According to another advantageous application of the invention, the hose element comprises or is constituted by a teat cup liner.

### BRIEF DESCRIPTION OF THE DRAWINGS

The present invention is now to be explained more closely through a description of various embodiments and with reference to the drawings attached hereto.

FIG. 1 discloses a side view of a hose element in the form of a teat cup liner according to a first application of the invention.

FIG. 2 discloses a side view of a hose element in the form of a short milk conduit according to a second application of the invention.

FIG. 3 discloses a side view of a part of a hose element according to a first embodiment of the invention.

FIG. 4 discloses a sectional view along the line IV-IV in FIG. 3.

FIG. 5 discloses another side view of the part in FIG. 3.

FIG. 6 discloses a sectional view of the hose element in a rest state along the line VI-VI in FIG. 3.

FIG. 7 discloses a sectional view similar to the one in FIG. 6, where the hose element is in a compressed state.

FIG. 8 discloses a sectional view similar to the one in FIG. 6 of a hose element according to a second embodiment of the invention.

FIG. 9 discloses a sectional view similar to the one in FIG. 6 of a hose element according to a third embodiment of the invention.

FIG. 10 discloses a side view of a part of a hose element according to a fourth embodiment of the invention.

FIG. 11 discloses a side view of a part of a hose element according to a fifth embodiment of the invention.

FIG. 12 discloses a sectional view similar to the one in FIG. 6 of a hose element according to a sixth embodiment of the invention.

### DETAILED DESCRIPTION OF VARIOUS EMBODIMENTS

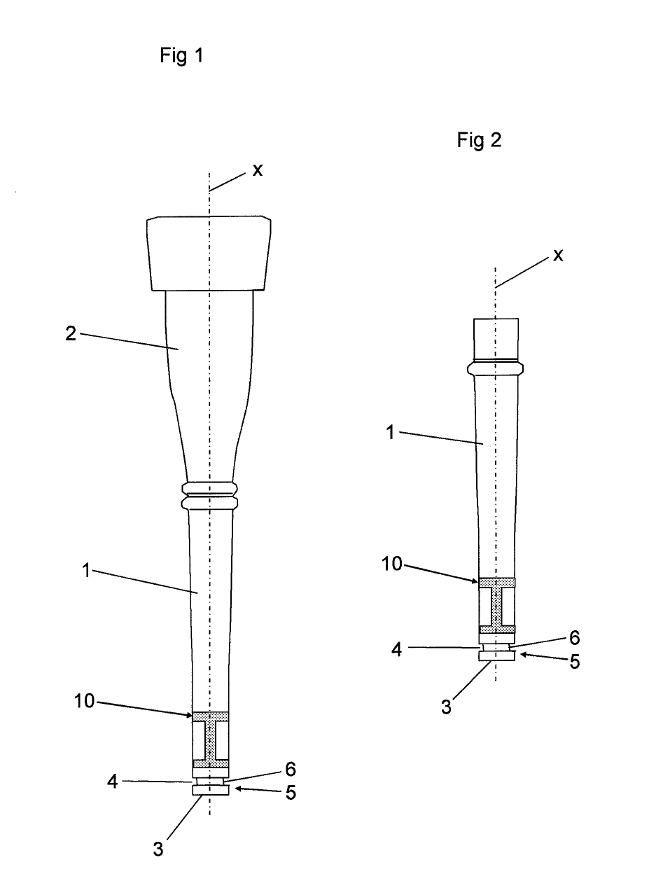

FIG. 1 discloses a hose element, which is configured for transporting milk and comprises a hose portion 1 and a teat cup liner portion 2 adapted to be mounted in a teat cup shell (not disclosed) to form a teat cup. The hose element is tubular and defines an inner channel 1′, see FIG. 4. The hose element has a first end 3. The hose portion 1 extends from the first end 3 along a longitudinal centre axis x of the hose element and the teat cup liner. In the embodiments disclosed, the hose portion 1 has, in a rest state, a circular, or substantially circular, cross-section. The hose portion may also have another cross-sectional shape, for instance an oval shape. The hose portion 1 is manufactured in a first material. The teat cup liner portion 2 may also be manufactured in the first material. The first material could be any suitable material normally used for teat cup liners, for instance natural or synthetic rubber, TPE, Thermal Plastic Elastomer, silicone elastomer or any other similar elastic polymer material.

The hose portion 1 comprises an attachment section 4 extending around the hose portion 1 in a peripheral direction with respect to the longitudinal centre axis x. The attachment section 4 is provided in the proximity of the first end 3. The attachment section and the first end 3 are enclosed by an end portion 5. In the embodiments disclosed, the attachment section 4 comprises or is constituted of a groove 6 extending around the hose portion 1 in a peripheral direction with respect to the longitudinal centre axis x.

The first end 3 and the attachment section 4 are configured to be introduced and received in an aperture of a further element (not disclosed), especially a claw of a milking member. Such an aperture is defined by an aperture edge. In the embodiments disclosed, the aperture edge will be received in the groove 6 when the hose element has been properly mounted in the aperture of the further element.

The hose element also comprises a mounting member 10 configured to facilitate the above-mentioned mounting of the hose element in the aperture.

FIG. 2 discloses a hose element according to a second application, which differs from the hose element of the first application in that it comprises no teat cup liner portion. The hose portion 1 of the hose element is adapted to be connected to a teat cup.

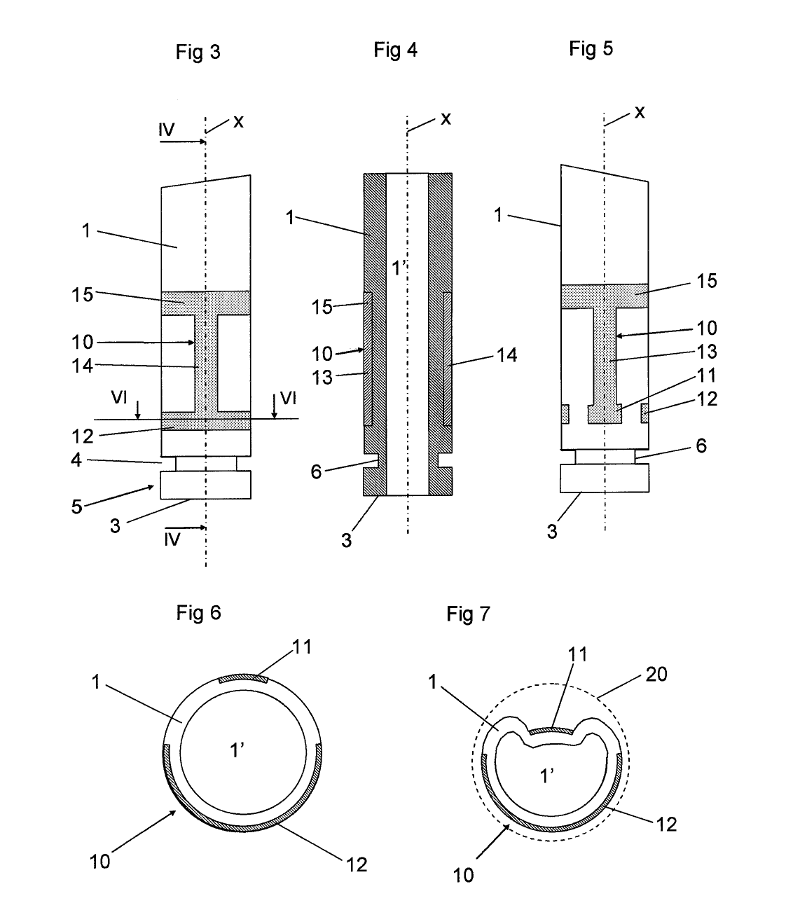

The mounting member 10 is disclosed more closely in FIGS. 3-5. It is to be noted that the mounting member 10 shown in these figures is merely an example of a possible design and that the design of the mounting member 10 may include numerous modifications.

The mounting member 10 comprises a primary portion 11, see FIG. 5 and an opposite secondary portion 12, see FIG. 3. The secondary portion 12 has an elongated shape and a relatively long extension in a circular peripheral direction with respect to the longitudinal centre axis x. Preferably, the peripheral extension of the secondary portion is at least 180°. The primary portion 11 has a rectangular shape as seen at the side view of FIG. 5. The shape of the primary portion 11 may, for instance, also be square, oval or circular, seen at the side view.

Furthermore, the mounting member 10 comprises a primary engagement part 13, see FIG. 5, and a secondary engagement part 14, see FIG. 3. Both the primary engagement part 13 and the secondary engagement part 14 have an elongated shape and extend in an axial direction with respect to the longitudinal centre axis x from the primary portion 11 and the secondary portion 12, respectively. The secondary engagement part 14 extends from a central point of the secondary portion 12, i.e. the secondary portion 12 projects laterally the same distance in opposite directions from the end of the secondary engagement part 14. Furthermore, the primary engagement part 13 and the secondary engagement part are disposed diametrically, or substantially diametrically, opposite to each other.

Furthermore, the primary engagement part 13 and the secondary engagement part 14 are both connected to a common connection part 15 extending around the hose portion 1 in a peripheral direction with respect to the longitudinal centre axis x.

The mounting member 10, i.e. the primary portion 11, the secondary portion 12, the primary engagement part 13, the secondary engagement part 14 and the connection part 15, is made of a second material, which is elastic but more rigid than the first material. The second material may for instance be polypropylen or any other suitable polymer material. Numerous materials can be chosen for the second material, for instance also metallic materials. The mounting member 10, i.e. the elements 11-15, constitutes an integrated tool joined in a permanent manner to the hose portion 1.

In the first embodiment disclosed in FIGS. 3-7, the mounting member 10 is joined to the hose portion 1 by being embedded in the first material. In the first embodiment, the mounting member 10 is disposed so that the outer surface of the mounting member 10 forms a part of the outer surface of the hose portion 1 and is smooth with the outer surface of the first material of the hose portion 1, see especially FIG. 6 disclosing a cross-section of the hose portion 1 in a rest state. It is to be noted that the mounting member 10 also may be completely embedded in the first material of the hose portion 1, i.e. in such a way that the mounting member 10 has no outer surface or inner surface adjoining the inner channel 1′.

When the hose element is to be mounted in an aperture of a further element, the user grips the hose portion 1, and more specifically the primary engagement part 13 and the secondary engagement part 14. These two parts 13 and 14 are then compressed from the rest state to a compressed state by being pressed towards each other. As can be seen in FIG. 7, the outer size of the hose portion 1 at the end portion 5 will then be significantly reduced. The original outer size of the hose portion 1 is indicated by the dashed line 20 in FIG. 7. Thanks to the provision of the primary portion 11, a part of the periphery of the hose portion 1 will be pressed inwardly thereby reducing the outer size and the diameter of the remaining peripheral part of the hose portion 1 at the level of the primary portion 11 to a shape roughly indicated in FIG. 7. The secondary portion 12 ensures that the outer cross-sectional shape of the hose portion remains circular or substantially circular at the peripheral portion of the hose portion 1 coinciding with the secondary portion 12.

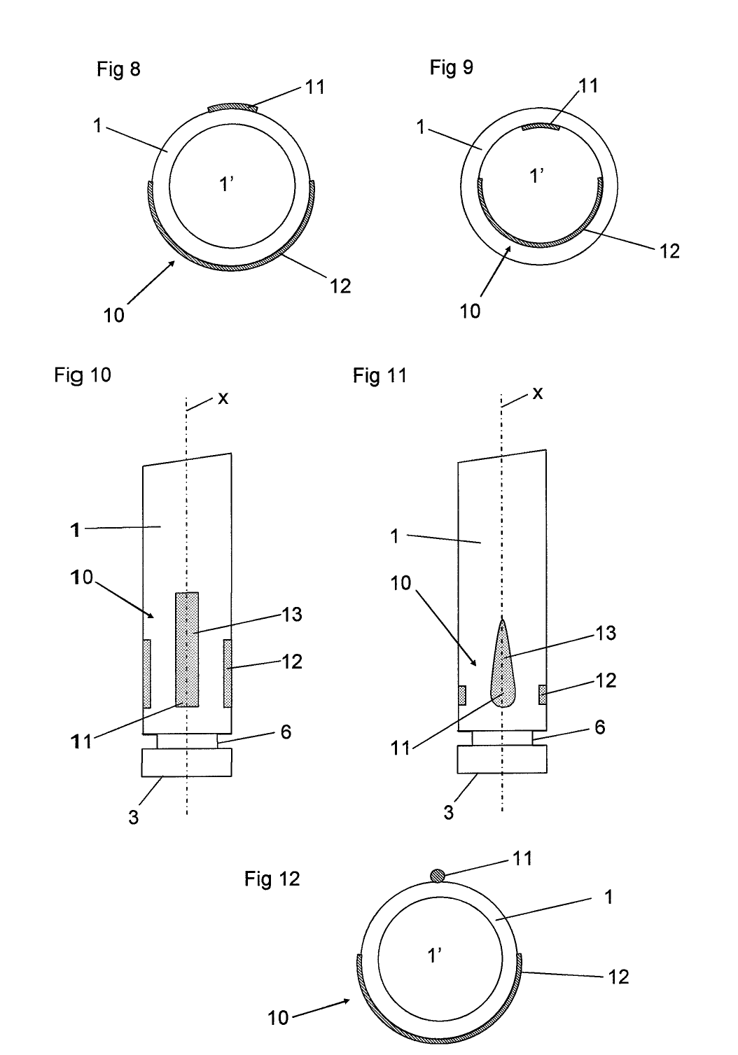

FIG. 8 discloses a second embodiment of the hose element, which differs from the first embodiment in that the mounting member 10 is joined to the outer surface of the first material of the hose portion 1. The mounting member 10 is also in the second embodiment permanently joined to the first material.

FIG. 9 discloses a third embodiment, which differs from the first and second embodiments in that the mounting member 10 is joined to the inner surface of the first material of the hose portion 1. Also in this case, the mounting member 10 is permanently joined to the first material.

It is to be noted that the mounting member 10 also may be partly embedded in the first material of the hose portion 1. In such a way, the mounting member 10 will protrude partly, i.e. with a part of its thickness, from the outer surface of the first material or the inner surface of the first material.

The joining of the mounting member 10, i.e. the elements 11-15, may be obtained by various means, for instance by a vulcanisation process or during moulding of the hose element, wherein the mounting member 10 prior to the moulding is placed in a mould. The joining of the mounting member 10 to the hose portion 1 may also be obtained by means of any suitable adhesive. Furthermore, the joining of the mounting member 10 to the hose portion may be obtained by the shape of the mounting member 10, wherein the mounting member 10 encloses the outer surface of the hose portion 1, see FIG. 8, or is enclosed within the hose portion 1, see FIG. 9. The elastic properties of the mounting member 10 will ensure that the mounting member 10 remains, thanks to a clamping action, on the hose portion 1 during mounting of the hose element, when the hose element is mounted and thus in use, and during dismounting of the hose element from the further element. It is also to be noted the hose portion 1 may include a depression or a groove extending from the outer surface or the inner surface and being suitable for receiving the mounting member 10. As a further alternative to vulcanisation or an adhesive, the depression or groove may have inclined side walls configured in such a way that the mounting member 10 will be locked in the depression or groove.

FIG. 10 discloses a fourth embodiment of the hose element, which differs from the first embodiment in that the mounting member 10 does not include a connection part. Consequently, the primary portion and the secondary portion 12 are formed as two separate portions, which are each joined to the hose portions 1 in a respective position corresponding to the positions of the primary portion 11 and the secondary portion 12 in the first embodiment. Also in the fourth embodiment, the mounting member 10 may be joined by vulcanisation, an adhesive or by inclined side walls of grooves or depressions. The secondary portion 12 may be joined by simply being clamped around the outer surface of the hose portion 1 or within the hose portion 1. As can be seen in FIG. 10, the secondary portion 12 has a relatively long axial extension, which is in the order of the axial extension of the primary portion 11. Thanks to such relatively long axial extension of the secondary portion 12, no specific secondary engagement portion is needed, but the user may grip directly the primary engagement portion 13 and the secondary portion 12 for compressing the hose portion 1.

FIG. 11 discloses a fifth embodiment, which differs from the fourth embodiment in that the primary engagement portion 13 has been given a smoother rounded shape, and that the axial extension of the secondary portion 12 is approximately the same as in the first embodiment. A secondary engagement portion is provided although it can not be seen in the side view of FIG. 11.

FIG. 12 discloses a sixth embodiment, in which the primary portion and the primary engagement portion 13 are configured as a, preferably cylindrical, rod extending in an axial direction. The rod may be a separate part joined to the hose portion 1 by vulcanisation or an adhesive. The rod may also be connected to the secondary portion 12 by means of a connection part as described in the first embodiment, wherein the mounting member may be joined to the hose portion 1 in any of the manners proposed above.

In the embodiments disclosed, the mounting member 10 has been positioned in such away that the primary portion 11 and the secondary portion 12 are located in the proximity of the attachment section 4 on the side which is turned away from the first end 3. It is to be noted that the primary portion 11 and the secondary portion 12 also may be located at the level of the attachment section 4, i.e. immediately inside the groove 6. Furthermore, the primary portion 11 and the secondary portion 12 may be located between the attachment section 4 and the first end 3.

The present invention is not limited to the embodiments disclosed but may be varied and modified within the scope of the following claims.

1. A hose element for a milking device, the hose element comprising
a first end (3),
a hose portion (1) of a first material, wherein the hose portion (1) extends from the first end (3) along a longitudinal centre axis (x) and has an outer size in a radial plane with respect to the longitudinal centre axis (x), and
an attachment section (4) extending around the hose portion (1) in a peripheral direction in the proximity of the first end (3),
characterised in that the hose element comprises a mounting member (10) of a second material which is joined to the hose portion (1), wherein the mounting member (10) comprises a primary portion (11) joined to the hose portion (1) in the proximity of the attachment section (4) and configured to permit, when being pressed inwardly towards the longitudinal centre axis (x), a reduction of the outer size of the hose portion (1) in an end portion (5).

2. A hose element according to claim 1, wherein the end portion (5) encloses the attachment section (4) and the first end (3).

3. A hose element according to claim 1, wherein the secondary material is elastic but more rigid than the first material.

4. A hose element according to claim 1, wherein the mounting member (10) comprises a secondary portion (12) joined to the hose portion (1) and disposed opposite to the primary portion (11).

5. A hose element according to claim 4, wherein the secondary portion (12) has a longer extension in a peripheral direction with respect to the longitudinal centre axis (x) than the primary portion (11).

6. A hose element according to claim 4, wherein the mounting member (10) comprises a secondary engagement part (14) extending axially from the secondary portion (12).

7. A hose element according to claim 6, wherein the secondary engagement part (14) has an elongated shape.

8. A hose element according to claim 4, wherein the secondary portion (12) is embedded in the first material of the hose portion (1).

9. A hose element according to claim 1, wherein the primary portion (11) is embedded in the first material of the hose portion (1).

10. A hose element according to claim 6, wherein the mounting member (10) comprises a primary engagement part (13) extending axially from the primary portion (11).

11. A hose element according to claim 10, wherein the primary engagement part (13) and the secondary engagement part (14) are disposed diametrically opposite to each other.

12. A hose element according to claim 11, wherein the primary engagement part (13) and the secondary engagement part (14) are connected to a common connection part (15) extending around the hose portion (1) in a peripheral direction with respect to the longitudinal centre axis (x).

13. A hose element according to claim 12, wherein the connection part (15) is a part of the mounting member (10) and made of the second material.

14. A hose element according to claim 10, wherein the primary engagement part (13) has an elongated shape.

15. A hose element according to claim 1, wherein the attachment section (4) comprises a groove (6).

16. A hose element according to claim 14, wherein the groove (6) is configured to permit the mounting of the hose element to a further element, comprising an aperture defined by an aperture edge, by engaging the aperture edge.

17. A hose element according to claim 1, wherein the hose element comprises a short milk conduit.

18. A hose element according to claim 1, wherein the hose element comprises a teatcup liner.

19. A hose element according to claim 2, wherein the secondary material is elastic but more rigid than the first material.

20. A hose element according to claim 1, wherein the mounting member (10) comprises a primary engagement part (13) extending axially from the primary portion (11).
